(19) United States
(12) Patent Application Publication
(10) Pub. No.: US 2006/0271425 A1
(43) Pub. Date: Nov. 30, 2006

(54) Advertising in application programs

(75) Inventors: Joshua T. Goodman, Redmond, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/139,750

(22) Filed: May 27, 2005

(51) Int. Cl. G06Q 30/00

(52) U.S. Cl. 705/14

(57) ABSTRACT

The subject invention provides a unique system and method that facilitates displaying content-targeted advertisements within applications running on an end-user or client computer. To mitigate privacy concerns, one or more advertisements can be stored on a client computer. At least one advertisement can be displayed on the client based at least in part on the context relating to the user's interaction with the client. By doing so, the user's private data or content is not passed to the server—meanwhile content-targeted advertising processing can be run on the user's content to determine which advertisements to display. Different forms of advertisements can be displayed to the user when the client is offline or online to facilitate optimizing use interaction with the advertisements and billing capabilities. To ensure that advertisements are displayed when content is displayed on a client, various encryption and decryption techniques can be employed to mitigate tampering of advertisement display code.

### TECHNICAL FIELD

The subject invention relates generally to advertising and in particular to advertising in application programs that run on an end-user computer in offline and online environments.

### BACKGROUND OF THE INVENTION

Advertising in general is a key revenue source in just about any commercial market. To reach as many consumers as possible, advertisements are typically presented via billboards, television, radio, and print media such as newspapers and magazines. However, with the advent and rise of the Internet, advertisers have found a new and perhaps less expensive medium for reaching vast numbers of potential customers across a large and diverse geographic span. Advertisements on the Internet can primarily be seen on web pages or web sites as well as in pop-up windows when a particular site is visited.

In addition to web sites on the Internet, businesses interested in generating revenues continue to look for other channels that may be suitable for advertisements. One current delivery mode, for example, involves presenting an advertisement to the user of an email system when the user views messages on his system. This is typically done when the provider of the email server software provides the service for free, such as many web-based email services. The subject matter of the advertisement may be selected according to the content of the incoming mail. Unfortunately, this raises many privacy concerns particularly for the mail recipient. This delivery mode can also be problematic for the advertiser since advertisements can now be automatically filtered and never be read by the recipient. Thus, there is a potential for a loss in advertising revenues as well as a loss of potential customers.

Typical advertising supported software systems today are web-based, such as a web-based email system, in which the email provider owns the servers on which the email is stored, and sends HTML pages containing the email content to the end-user, perhaps with ads embedded in the HTML pages. In this case, the end-user has already made a decision to trust the service provider with the content of his data, and may not be overly worried about the privacy implications of the service provider automatically scanning the data for the purposes of content targeted advertising. But in other possible scenarios, such as a free, advertising-supported word processor, the data is not typically stored or accessible to the provider of the software. It is thus desirable to find a way to target ads to users such that privacy is not violated.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention provides a system and method that facilitates delivering and displaying content-targeted advertisements in application programs such as word processing programs, email programs, or any other application that can be run on an end-user machine. Content-targeted advertisements can be sent from a network or server to a client or user's computer. Currently, targeted advertisements have been concentrated in online computing environments such as when browsing the Internet or sending or receiving messages via the Internet. In either of these scenarios, users acknowledge that their messages can be screened by a message server or provider to determine which advertisements to show to them. Application programs raise distinct challenges for targeted advertising. Users tend to be less comfortable with a server screening their documents, files, etc. In addition, application programs can be used offline as well as online, thus creating additional hurdles to overcome for advertisers. Advertising can generate increased revenues and profits for a business. To protect their investment, advertisers desire some assurance that their advertisements are being displayed via the application programs. Thus, another obstacle to overcome concerns verifying that the advertising display code has not been modified or tampered with within an application program.

The subject invention addresses these various challenges in different ways. Regarding the privacy concerns, the invention involves downloading a plurality of advertisements to a user's computer from a server (e.g., Internet, intranet, or other network). At an appropriate time, content-targeted advertisements can be processed against at least a portion of the user's private data to determine which advertisements to display to the user—in the relevant active or inactive application program (e.g., word processing application). As a result, the user's private data is not exposed to the server.

Some application programs such as email or other messaging programs allow data to be stored on the server. In such cases, the data can be stored in encrypted form on the server and the client can keep the key. Thus, the server does not need to see the user's private data but can still conduct targeted advertising with respect to such data. This can be accomplished in part by downloading and decrypting the desired data on the client via the client and then running the content-targeted advertisements stored on the client against the decrypted data.

Whether online or offline, advertisements can be displayed to the user, however, the type or format of the advertisements may differ depending on whether the user is determined to be online or offline. When the user is offline, for example, brand advertising, pay per call advertisements, and/or printable coupons are a few options available to an advertiser. These offline formats can be downloaded to the user's computer and cached while the user is online. In some cases, a user may be able to click on an ad for additional information, even when the user is offline. In these instances, the additional information may have been previously cached with the offline content while the user was online. Thus, when the user clicks on an offline advertisement, he/she can be directed to the additional information.

When the user reconnects to the server, any recorded click-through activity while offline can be sent to the appropriate party via the server. In addition, advertisements can be updated on the user's computer.

To be sure that the targeted advertisements are displayed on the user's computer when the user's content (e.g., email) is displayed in certain types of applications such as messaging clients, encryption techniques can be employed. In particular, both the message (e.g., email) and the corresponding targeted advertisement(s) can be encrypted at the server. When access to such messages is desired by the user, the message client or client software can decrypt the data using a key that only the client knows. Thus, the client can decrypt the content of the message and the advertisement(s) and display the content to the user. Only clients that are known to display the advertisement are provided with the decryption key. The decryption key is not shared with the user to mitigate tampering with the display of the advertisements. This provides an additional assurance to advertisers and advertising providers that such advertisements are in fact being displayed as intended. As one more layer of protection, at least a portion of the client software holding the key can be encrypted as well.

In general, advertisements or advertising space can be sold via an auction model. Other security features can also be employed to verify that the advertisement display program within an application has not been modified and that advertisements are shown as intended by the advertisers. The display of some advertisements can be subject to time-out or other expiration-related periods. When an advertisement has timed-out or their expiration period is satisfied, the advertisement can be removed from the computer's cache or be marked in some way to prevent it from being displayed again.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a system that facilitates displaying content-targeted advertisements and that mitigates privacy concerns in accordance with an aspect of the subject invention.

FIG. 2 is a block diagram of a system that facilitates delivery and display of content-targeted advertisements on a client depending on whether the client is online or offline in accordance with an aspect of the subject invention.

FIG. 3 is a block diagram of a system that facilitates controlling the functionality of any application program on a client based on a level of advertising permitted by the user in accordance with an aspect of the subject invention.

FIG. 4 is a block diagram of a system that facilitates preserving privacy of content stored on a server while running content-targeted advertisement processing on at least a portion of that content accessed by the client in accordance with an aspect of the subject invention.

FIG. 5 is a flow chart illustrating an exemplary methodology that facilitates delivery to and display of content targeted advertisements in an application on a client machine in accordance with an aspect of the subject invention.

FIG. 6 is a flow chart illustrating an exemplary methodology that facilitates updating advertisements stored on the client of FIG. 5 when the client is online in accordance with an aspect of the subject invention.

FIG. 7 is a flow chart illustrating an exemplary methodology that facilitates controlling a level of functionality of an application on a client based on a level of advertising permitted by the user in accordance with an aspect of the subject invention.

FIG. 8 is a flow chart illustrating an exemplary methodology that facilitates ensuring that the content-targeted advertisements selected for display on the client-run application is displayed in accordance with an aspect of the subject invention.

FIG. 9 is a flow chart illustrating an exemplary methodology that further facilitates ensuring that the content-targeted advertisements selected for display on the client-run application is displayed in accordance with an aspect of the subject invention.

FIG. 10 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with selecting and/or presenting content-targeted advertisements to users based on the content of the users' active document or file object(s) and/or the users' geographic, demographic, and/or profile information. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

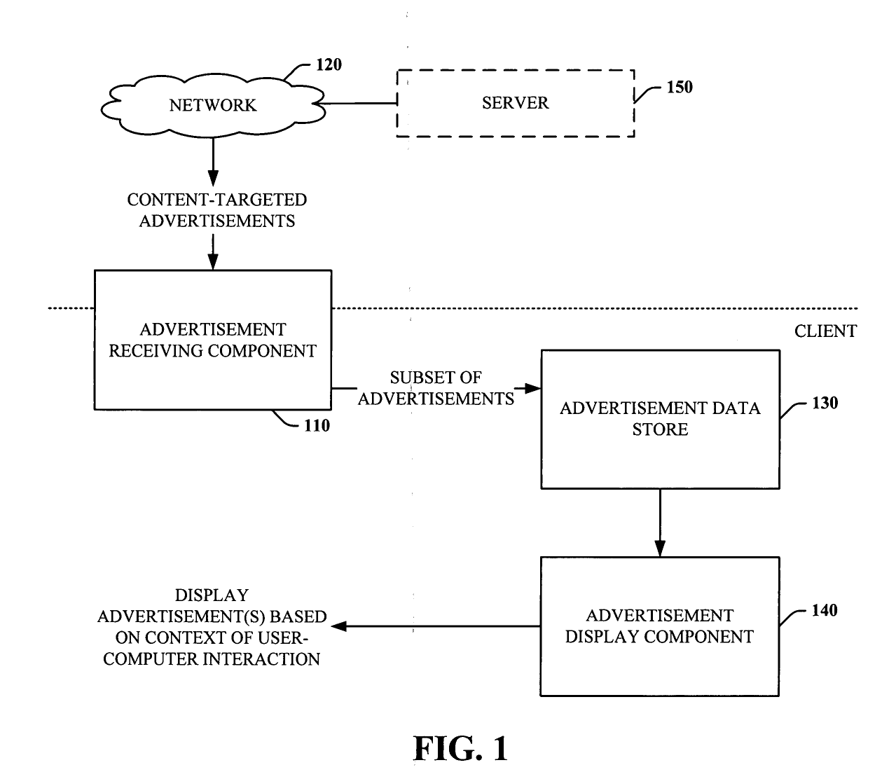

Referring now to FIG. 1, there is a high-level block diagram of a system 100 that facilitates the display of content-targeted advertisements in accordance with an aspect of the subject invention. The system 100 comprises an advertisement receiving component 110 that can receive one or more content-targeted advertisements from a network 120 or server. At least a subset of the advertisements can be stored on a client such as in an advertisement data store 130. An advertisement display component 140 can display at least one advertisement from the subset of advertisements as a function of context relating to a user-computer interaction.

In practice, the system 100 mitigates privacy concerns in part by keeping the user's private data (e.g., contents of documents, files, etc. in an application) out of the view of the server or network 120. That is, when a user is reading a document in a word processing application, the contents of the document are not screened by the network 120 to determine which targeted advertisements relate the closest to the document. Instead, a plurality of advertisements can be downloaded and stored on the user's computer (client). When the user has accessed a document or file, the client can screen the document and run a content-targeted advertising process to determine and display the most relevant advertisements—based on the content of the user's document. Hence, the server is not contacted and no information is passed to the server until the user clicks on an advertisement. The user's click of an advertisement can trigger the server to access and send more ad-related information to the user based on the click data.

For some applications in which data or content is stored on a server, the content can actually be stored in encrypted form on the server. The client maintains possession of the key so that the network 120 or server 150 connected to the network does not see the user's private content, and yet can still conduct content-targeted advertising for content stored on the server. An example might be a “backup in the sky” type application or a “data in the cloud” application, in which a user can store his/her content on a server accessible from anywhere. The content can include any storable object such as documents, emails, photos, and the like.

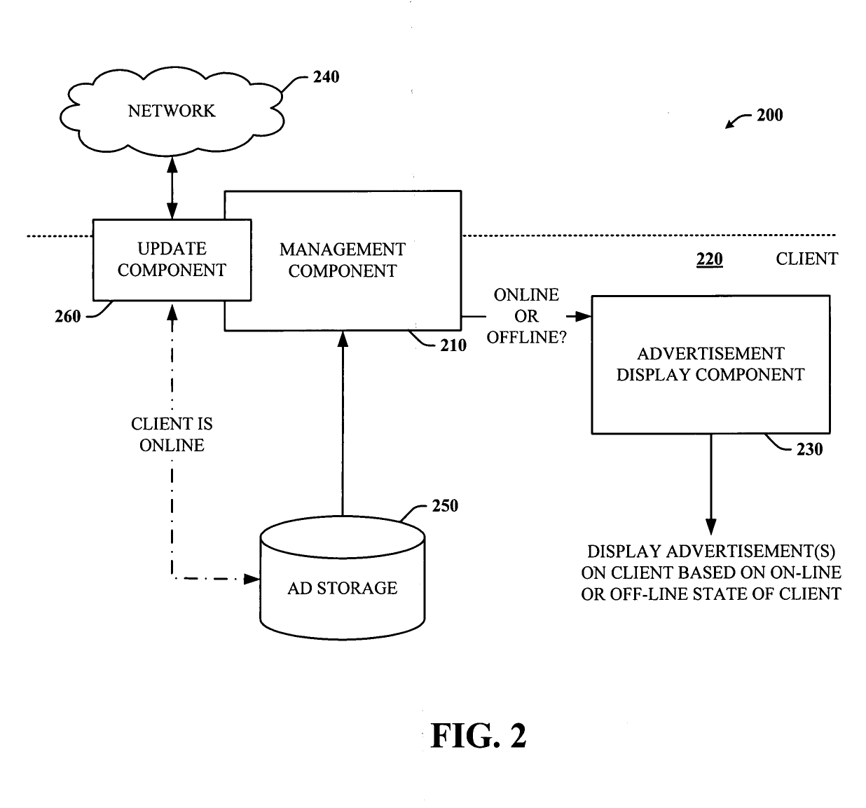

Referring now to FIG. 2, there is demonstrated a system 200 that facilitates displaying content-targeted advertisements to users when offline or online in accordance with an aspect of the subject invention. The system 200 includes a management component 210 that can detect and/or determine whether the client 220 is online or offline and an advertisement display component 230 that can select one or more advertisements to display based on whether the client 220 is online or offline. When offline, the network 240 (e.g., Internet) cannot monitor click-through of advertisements (e.g., for billing purposes) and new advertisements or ad-related information cannot be sent to the client 220 for display to the user. Thus, click-targeted advertisements such as “Click here to buy this book at Giantbookstore.com” are largely if not completely ineffective when the user and client 220 are offline.

When the client 220 is offline, different types or formats of advertisements can be employed. Examples include brand advertising such as “Drink Cola W” and phone-based advertising. A type of phone-based advertising includes pay per call advertisements. Pay per call advertisements can recite messages such as “Call 800-555-5555 to apply for Bank $ Credit Card”. For instance, imagine that Bank $ advertises through MNO Networks. MNO Networks or Bank $ can set up a special phone number that is specific to this advertisement. MNO Networks can monitor all traffic on that phone line or Bank $ can send MNO Networks their incoming call list and/or phone records. In either case, MNO Networks can ascertain the volume of traffic generated on the phone line by the advertisement and bill Bank $ on a per-call or per time-increment basis.

Printable coupons can also be displayed as advertisements. Regardless of the type of offline advertisements employed, they should be stored to the client's ad storage database 250 while the client is online.

Although click-through activity with the network is not feasible when offline, users may still be able to click on offline advertisements to view additional content. However, the additional content should be cached on the client computer while the client is online. Thus, when a user clicks on an offline advertisement, he/she can be directed or shown more information regarding the advertisement—assuming that this information was stored to the client's memory before going offline. Any click data (e.g., number of impressions of each advertisement and number of advertisements where users clicked for more information) can be recorded and/or tracked while the client is offline.

When the management component 210 detects that the client is online again, an update component 260 can selectively update the advertisements in the ad storage database 250. The updates may include removing expired advertisements, adding new advertisements, and/or replacing older versions of advertisements with newer versions. The user can be required to periodically connect to the network 240 to synchronize his advertisements. For example, users can be required to periodically reconnect to the network 240 in order to continue use of a free version of application software. Otherwise, some functions within the software may be disabled (e.g., put in read-only mode) until the user establishes a connection to the network 240.

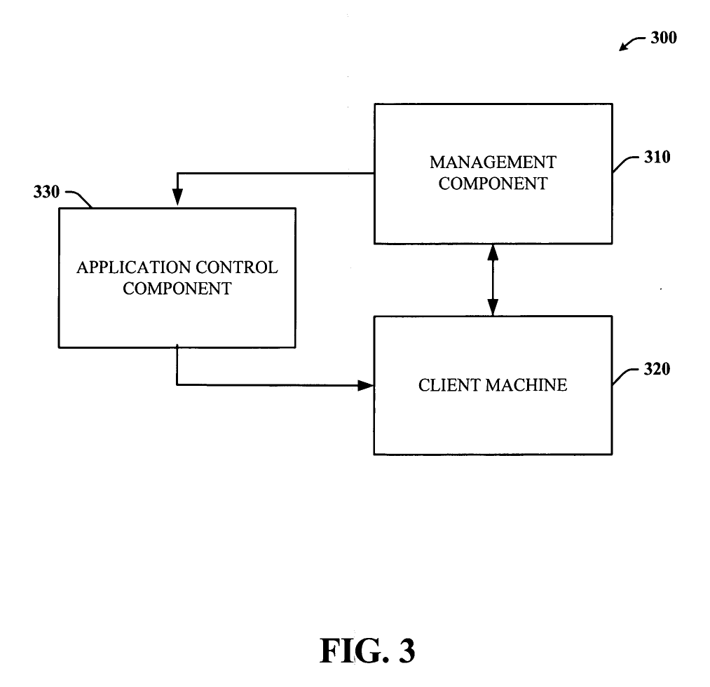

Turning now to FIG. 3, there is illustrated a system 300 that facilitates controlling the functionality of any application program on a client based on a level of advertising permitted by the user in accordance with an aspect of the subject invention. The system 300 includes a management component 310 that determines the level of advertising allowed by a user on the client computer or machine 320. A higher level of advertising can cause an application control component 330 to grant full functionality of an application to the client machine 320. However, lower levels of advertising can cause one or more functions of the application to be disabled or otherwise restricted.

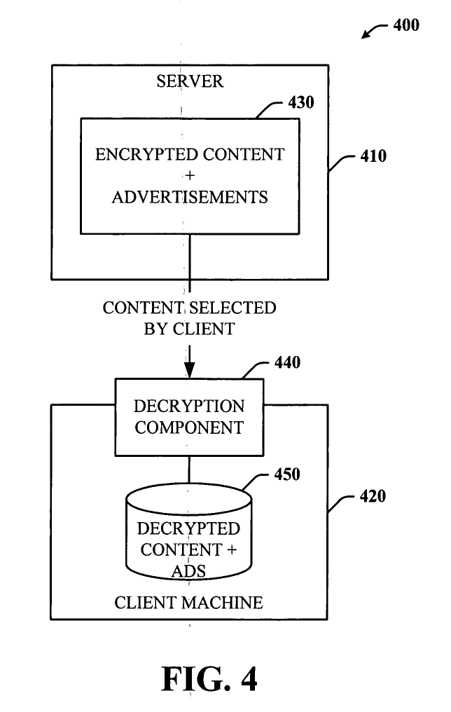

Referring now to FIG. 4, there is represented a system 400 that facilitates displaying content-targeted advertisements in application programs in accordance with an aspect of the subject invention. The system 400 includes a server 410 and at least one client machine 420. The server 410 has stored therein encrypted content and encrypted advertisements 430 which may correspond to such content. When certain content from the server 410 is desired by the user, such encrypted data can be sent to the client 420, whereupon it can be decrypted by a decryption component 440 and stored in a suitable database 450. The client 420 can use a decryption key that is not revealed to the user to ensure that the user does not and cannot tamper with the display of such advertisements. In fact, the program or software code holding the decryption key on the client can be encrypted as well as an added security measure.

The system 400 can be particularly relevant to some applications which can run client code on the client computer while talking to a server. The server may be advertising supported. The server software may also want to deliver the advertisements to the client software and to be sure that they are displayed. If a simple protocol were used, like the standard POP email protocol, then any client software could connect, and no advertisements would necessarily be displayed. Alternatively, a special protocol can be used. However, an immoral user could create email client software that uses this special protocol and display email without the advertisements. Thus, the server software can encrypt the email using a key specific to the client software.

However, an immoral user could decode the client software and find the place where the secret key is stored and then create their own client software that does not display the advertisements. Alternatively, an immoral user could decode the client software and delete the part of the code that displays the advertisements. To prevent both of these scenarios, the client software can employ technology to hide the secret key, similar to the technology used for Digital Rights Management to hide keys, and to make sure that key parts of the code, particularly sections that display advertising, have not been modified or tampered with in any way. A number of techniques can be used to achieve this goal. For example, the software code itself can be encrypted and decrypted on the fly. In particular, the code containing the secret key can be encrypted. Before the code is decrypted, the client or some other system component can check for debuggers or breakpoints. Additionally, code can be inserted that checksums critical sections, including advertising code, and fails to decrypt the message or otherwise function correctly if undesirable modifications are detected. Finally, use of trusted hardware can be employed to make sure that the decryption code remains secret. The trusted hardware can verify that the advertising code has not been tampered with.

It may be particularly convenient to use public key cryptography for the encryption. The public key can be freely given for server software, while the private key can be stored (encrypted) in the client. There may be a single public key for all client software, or there may be one public key/private key pair for each user of the client software. Using public key cryptography allows multiple servers to display ads for a given client. For instance, a version of an email application can be sold that would work with many different mail servers. The public keys can be signed, and subject to revocation checks. In this way, a client can connect up to its server and deliver its signed public key. The server can check the signature and then use the public key to deliver encrypted content using a special API that encrypts the message with the public key and sends advertising. The advertising should be encrypted with the message content, to prevent modification. The public key information could be given to various mail servers without worrying that they could then build versions of the client software without advertisements (e.g., content-targeted advertisements). The server may instead use the public key to transmit a session key for a symmetric encryption algorithm to the client, and then encrypt the data and advertising using the session key, which provides similar protection, but may be more efficient.

If an abnormally high number of clients are using a particular public key, that public key can be revoked—and placed on a certificate revocation list. The list can be checked or referenced periodically to determine whether a public key's certificate has gone bad.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

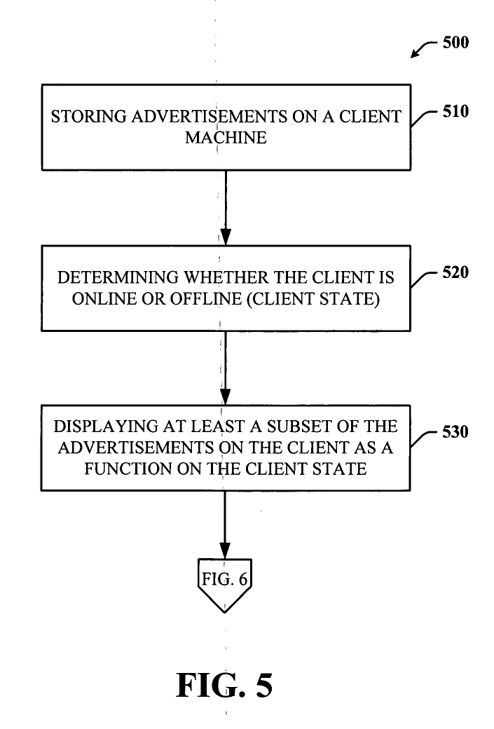

Referring now to FIG. 5, there is a flow diagram of an exemplary method 500 that facilitates display of content targeted advertisements with respect to application programs in accordance with an aspect of the subject invention. The method 500 involves storing advertisements on a client machine at 510. For example, advertisements can be downloaded from the Internet or other network or server and stored on the client. At 520, the method 500 can determine whether the client is online or offline. At least a subset of advertisements stored on the client can be displayed to the user based on the client's state (offline or online) at 530. That is, different forms of advertisements can be displayed to the user when offline since the user's ability to interact with any advertisement can be somewhat limited. For instance, an advertiser may choose to display brand or phone-based advertisements rather than click-based advertisements when a client is offline.

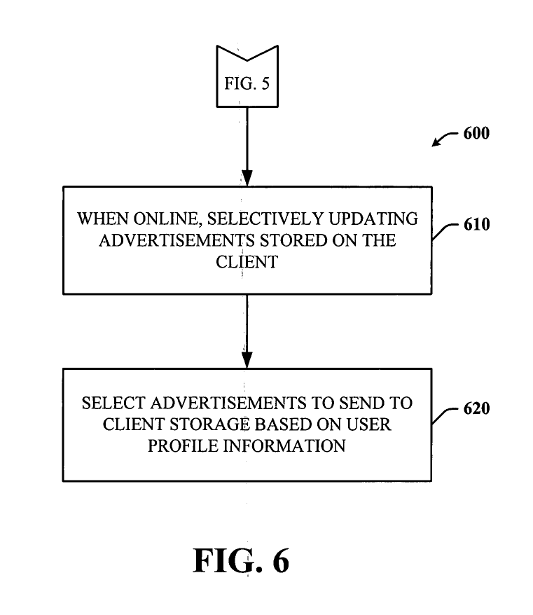

Continuing on to FIG. 6, an exemplary method 600 that facilitates updating advertisements stored on the client of FIG. 5 when the client is online is shown. When online, advertisements stored on the client can be selectively updated at 610. For example, advertisements which have “timed-out” or expired can be removed from the client's storage and replaced with more current advertisements. In addition, advertisements can be selected to be sent to the client's storage that are based on the user's profile information including but not limited to the user's demographic and/or geographic information.

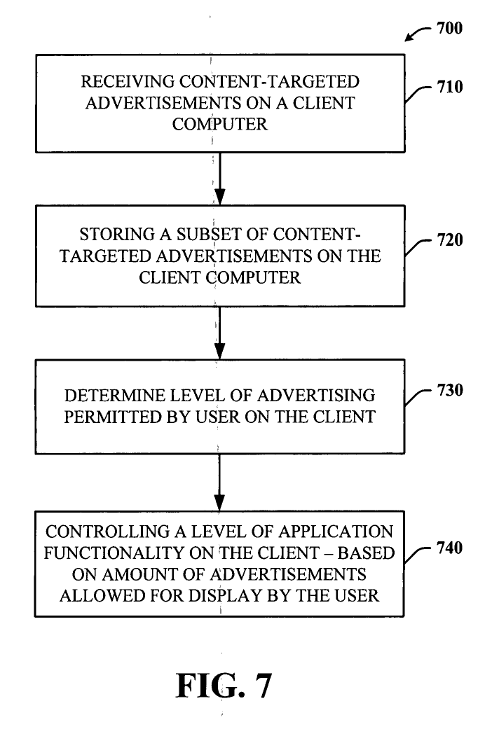

Turning now to FIG. 7, there is illustrated a flow diagram of an exemplary method 700 that facilitates controlling a level of functionality of an application on a client. The method 700 involves receiving one or more content-targeted advertisements on a client computer at 710 and storing at least a subset of the advertisements on the client computer at 720. At 730, a level of advertising permitted by the user on the client can be determined and the level of functionality of at least one application running on the client can be regulated or controlled at 740 based on the level of advertising allowed by the user.

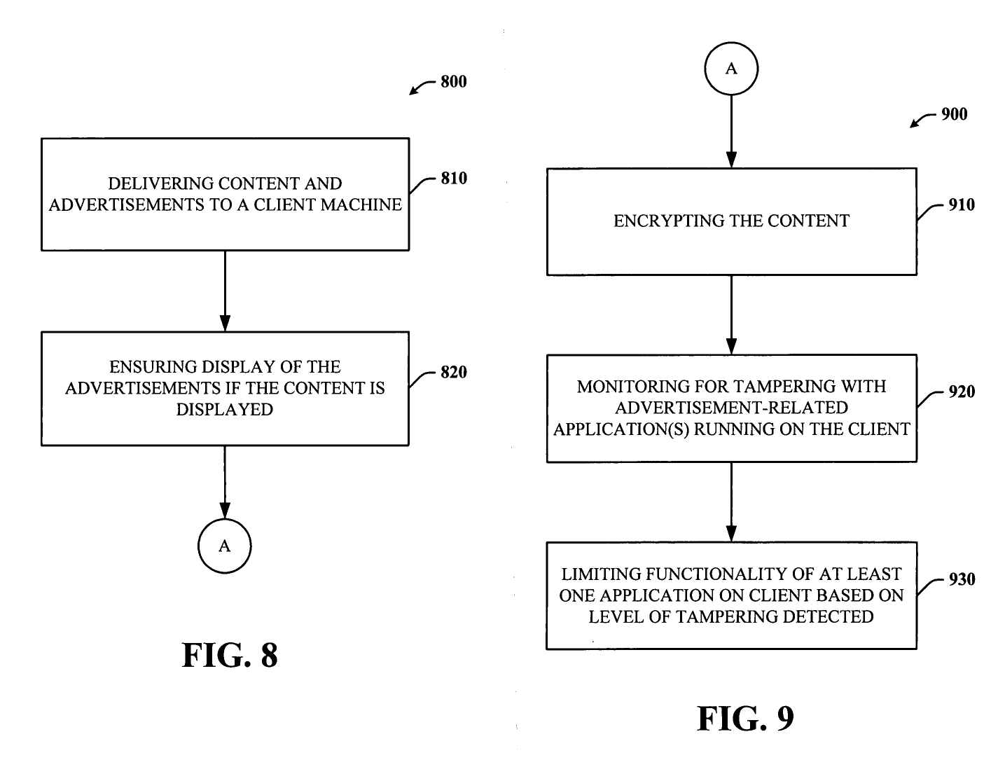

In FIG. 8, there is a flow chart demonstrating an exemplary method 800 that facilitates ensuring that the content-targeted advertisements selected for display on the client-run application is displayed in accordance with an aspect of the subject invention. The method 800 involves delivering content and advertisements to a client machine at 810 and ensuring the display of the advertisements if and/or when the content is displayed at 820.

An exemplary method 900 as shown in FIG. 9 may follow to further facilitate ensuring that the content-targeted advertisements selected for display on the client-run application is displayed. The method 900 can continue with encrypting the content, whereby the encryption used can employ a public key such that only trusted clients have the corresponding private keys. In addition, a certificate of authenticity for the public key can be provided by a trusted party. At 920, the method 900 can monitor for tampering with advertisement-related applications running on the client. If any tampering is discovered, the functionality of at least one application on the client can be limited based on the level of tampering detected (at 930).

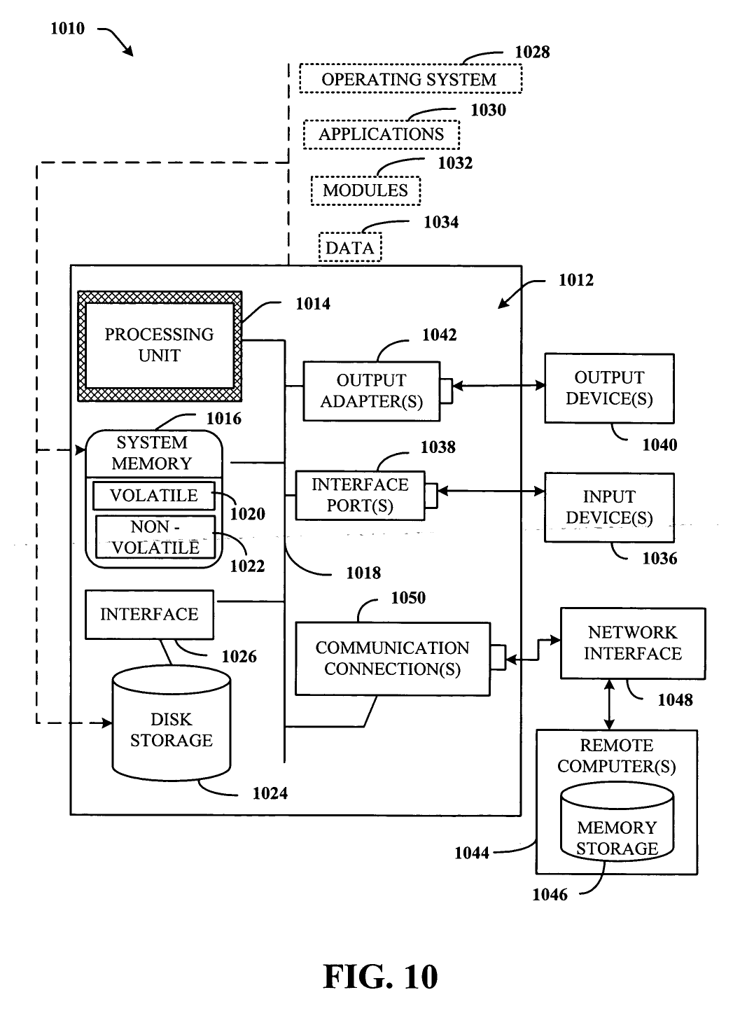

In order to provide additional context for various aspects of the subject invention, FIG. 10 and the following discussion are intended to provide a brief, general description of a suitable operating environment 1010 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1010 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates display of content-targeted advertisements, comprising:
a component that receives content-targeted advertisements and stores a subset of the advertisements on a client computer; and
an advertisement display component that displays advertisements from the subset of advertisements as a function of context relating to user computer interaction, the context relating to at least one of the following: online/offline status; content of a textual interaction; or geographic or demographic information about the user.

2. The system of claim 1 further comprising a management component that determines if the client computer is on-line or off-line, the advertisement display component selecting advertisements to display as a function of whether the computer is on-line or off-line.

3. The system of claim 1, further comprising a component that controls level of functionality provided in connection with an application program employed by the client computer as a function of level of advertising permitted by the user.

4. The system of claim 1, further comprising a security component that determines if software relating to advertisement display has been modified.

5. The system of claim 2, further comprising an update component that selectively updates advertisement stored on the client computer when the client computer is on-line.

6. The system of claim 1, the subset of advertisements is selected in part as a function of geographic and/or demographic information relating to at least one user of the client computer.

7. The system of claim 1, further comprising a server that stores content in an encrypted form that is received and decrypted by the client computer.

8. A computer implemented method that facilitates delivery of content-based advertisements, comprising:
storing advertisements on a client computer;
determining whether the computer is on-line or offline; and
displaying a subset of the advertisements on the client computer as a function of whether the computer is on-line or off-line.

9. The method of claim 8, further comprising monitoring click through activity on the client computer, and upon the client computer being on-line delivering the click through activity information to another computer.

10. The method of claim 8, further comprising selling the advertisements via an auction model.

11. The method of claim 8, further comprising employing time-out periods for the subset of advertisements, wherein the time-out periods can be a function of frequency of display, duration of storage on the client computer, inapplicability of the advertisement, and/or storage capacity of the client computer.

12. The method of claim 8, wherein the subset of advertisements are content-targeted.

13. The method of claim 8, wherein the subset of advertisements are selected at least in part as a function of user geographic and/or demographic profile.

14. The method of claim 8, the subset of advertisements comprises pay-per call advertisements.

15. A computer readable medium having stored thereon computer executable instructions for carrying out the acts of claim 8.

16. A computer-implemented method that facilitates display of content, comprising:
delivering content and advertisements to a client computer; and
ensuring display of the advertisements if the content is to be displayed.

17. The method further comprising encrypting the content.

18. The method of claim 17, encrypting the content comprises employing encryption that uses a public key such that only trusted clients have corresponding private keys.

19. The method of claim 18, further comprising receiving a certificate of authenticity for the public key provided by a trusted party.

20. The method of claim 16, further comprising monitoring for tampering with advertisement-related software running on the computer, and limiting functionality of the application program as a function of tampering.
